(19) United States
(12) Patent Application Publication
(10) Pub. No.: US 2025/0173962 A1
(43) Pub. Date: May 29, 2025

(54) METHOD AND SYSTEM FOR CREATING 3D OBJECTS FROM ROUGHLY DRAWN SKETCH AND TEXT

(71) Applicant: Korea Electronics Technology Institute, Seongnam-si (KR)

(72) Inventors: Jeong Min LEE, Seongnam-si (KR); Sa Im SHIN, Seoul (KR); Jung Ho KIM, Seoul (KR); Bo Eun KIM, Seoul (KR)

(73) Assignee: Korea Electronics Technology Institute, Seongnam-si (KR)

(21) Appl. No.: 18/933,446

(22) Filed: Oct. 31, 2024

(30) Foreign Application Priority Data
Nov. 27, 2023 (KR) 10-2023-0166905

(51) Int. Cl. G06T 17/00

(52) U.S. Cl. CPC G06T 17/00

(57) ABSTRACT

There are provided a method and a system for creating 3D objects from an unstructured sketch and a text. A 3D object creation method according to an embodiment includes: receiving input of a sketch and a text on a 3D object to create; acquiring a text on the 3D object; creating a 2D image from the sketch and the text; and creating a 3D object from the 2D image. Accordingly, an individual user can create various 3D objects based on a rough sketch and a text without background knowledge on 3D asset authoring in various genres, such as animations, games, fashion, etc., and can directly use the 3D objects as high-quality 3D assets without an additional post-process in each field.

### CROSS-REFERENCE TO RELATED APPLICATION(S) AND CLAIM OF PRIORITY

This application is based on and claims priority under 35 U.S.C. § 119 to Korean Patent Application No. 10-2023-0166905, filed on Nov. 27, 2023, in the Korean Intellectual Property Office, the disclosure of which is herein incorporated by reference in its entirety.

### BACKGROUND

### Field

The disclosure relates to an artificial intelligence (AI)-based three-dimensional (3D) object creation technology, and more particularly, to a method for automatically creating 3D objects from an unstructured sketch which is roughly drawn by user's hand.

### Description of Related Art

To create high-quality 3D contents, a series of processes, such as 3D modeling using a 3D model authoring tool, texturing to express color and surface information on a 3D model, high-polygon modeling or sculpting for final finetuning, is required.

In each process, a specialized authoring tool such as Computer-Aided Design (CAD), Blender, Illustrator, Photoshop is typically used based on expertise of the corresponding field. However, it may be difficult for an individual user to understand and use a tool of each step, and costs may be a burden.

To this end, there may be a problem that creators cannot create satisfactory 3D contents without advanced authoring skills or spending great expense, and accordingly, there is a need for a solution to solve this.

### SUMMARY

The disclosure has been developed in order to solve the above-described problems, and an object of the disclosure is to provide a method and a system for supporting high-quality 3D content creation based on a rough sketch and a text of a user who is not an expert for creating 3D objects and has no prior knowledge.

According to an embodiment of the disclosure to achieve the above-described object, there is provided a 3D object creation method, including: receiving input of a sketch on a 3D object to create; acquiring a text on the 3D object to create; creating a 2D image from the sketch and the text; and creating a 3D object from the 2D image.

The sketch may be a picture of the 3D object which is directly drawn by a user.

Acquiring may include acquiring the text by receiving the text with the input of the sketch from the user.

The text received from the user may be a text by which the user describes characteristics of the 3D object.

According to the disclosure, the 3D object creation method may further include generating a plurality of texts by modifying the text inputted from the user, and creating the 2D image may include creating a plurality of 2D images from the sketch and the plurality of texts, and creating the 3D object may include creating a plurality of 3D objects from the plurality of 2D images.

Acquiring may include: recognizing features by extracting feature points of the received sketch; and generating a text explaining the sketch based on the recognized features.

The generated text may include at least one of a class of an object appearing in the sketch and a semantic description.

According to the disclosure, the 3D object creation method may further include generating a plurality of texts by modifying the generated text, and creating the 2D image may include creating a plurality of 2D images from the sketch and the plurality of texts, and creating the 3D object may include creating a plurality of 3D objects from the plurality of 2D images.

According to the disclosure, the 3D object creation method may further include extracting a depth map from the 2D image, and creating the 3D object may include creating the 3D object from the 2D image and the depth map.

According to another aspect of the disclosure, there is provided a 3D object creation system including: a processor configured to receive input of a sketch on a 3D object to create, to acquire a text on the 3D object to create, to create a 2D image from the sketch and the text, and to create a 3D object from the 2D image; and a storage unit configured to provide a storage space necessary for the processor.

According to still another aspect of the disclosure, there is provided a 3D object creation method including: receiving input of a sketch on a 3D object to create; acquiring a text on the 3D object to create; creating a 2D image from the sketch and the text; creating a 3D object from the 2D image; and outputting the generated 3D object.

As described above, according to embodiments of the disclosure, the method enables an individual user to create various 3D objects based on a rough sketch and a text without background knowledge on 3D asset authoring in various genres, such as animations, games, fashion, etc., and to use high-quality 3D assets directly without an additional post-process in each field.

According to embodiments of the disclosure, additional text input may compensate for an ambiguity problem arising in sketch input, and a text prompt on the sketch may be automatically generated, thereby assisting in high-quality 3D content authoring.

According to embodiments of the disclosure, a plurality of texts may be generated by modifying a text, and 3D objects of various styles may be created with respect to a single sketch.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a sketch/text-based 3D object creation method;

FIG. 2 is a sketch-based 3D object creation method;

FIG. 3 is a view illustrating a sketch/text/depth map-based 3D object creation method;

FIG. 4 is a view illustrating a sketch/depth map-based 3D object creation method; and

FIG. 5 is a view illustrating a 3D object creation system.

### DETAILED DESCRIPTION

Hereinafter, the disclosure will be described in more detail with reference to the accompanying drawings.

Embodiments of the disclosure provide a method and a system for creating 3D objects from an unstructured sketch and a text.

The disclosure relates to a technology for enabling a normal user, who has no background knowledge on 3D content creation, to do 3D object authoring based on a rough sketch or input of a sketch and a text without learning 3D object authoring processes, by applying an analysis technology to the sketch and text based on a large-scale AI pretrained model.

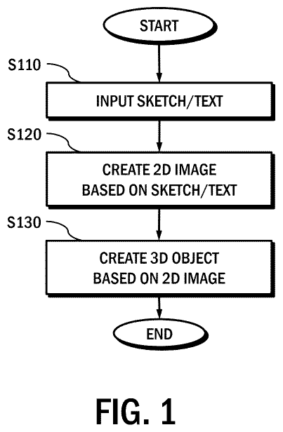

FIG. 1 is a flowchart of a 3D object creation method according to an embodiment of the disclosure. In an embodiment, an unstructured sketch and a text are inputted from a user, and a 3D object is created.

First, a sketch on a 3D object to create and a text explaining characteristics of the 3D object are inputted (S110). The text is freely written by a user about the shapes, colors, textures, static/dynamic characteristics of the 3D objects.

Text input is to compensate for an ambiguity problem arising in the sketch. When the user draws a sketch about the 3D object, an AI model may recognize differently from user's intention due to the rough sketch, and hence, information on the 3D object that the user wants to create may be added as a text.

A 2D image is created from the sketch and the text inputted at step S110 (S120). Step S120 may be performed by a using a machine learning model which is trained to create a 2D image from a sketch and a text.

A 3D object is created from the 2D image created at step S120 (S130). Step S130 may be performed by using a machine learning model which is trained to create a 3D object from a 2D image.

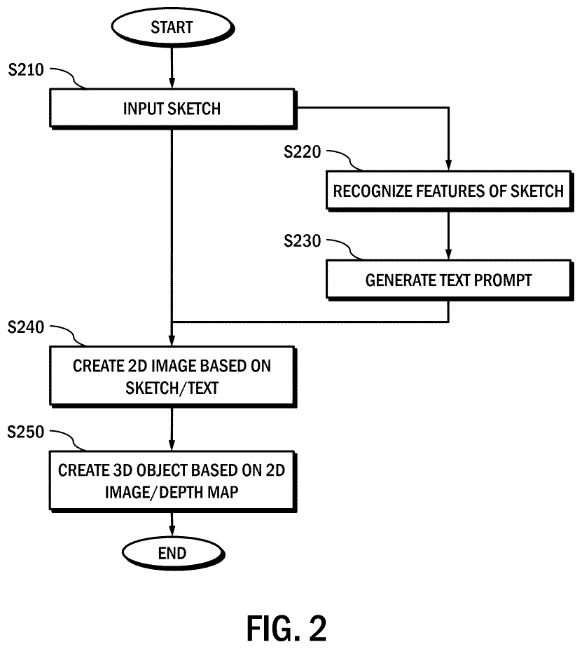

FIG. 2 is a flowchart of a 3D object creation method according to another embodiment of the disclosure. In the embodiment of the disclosure, a 3D object is created only with an unstructured sketch without input of a text.

A sketch on a 3D object to create is inputted (S210). Features are recognized by extracting feature points of the sketch inputted at step S210 (S220), and a text prompt explaining the sketch is generated based on the recognized features (S230).

The text prompt generated at step S230 may include the class (category) of an object appearing in the sketch, and semantic descriptions. Steps S220 and S230 may be performed by using a machine learning model which is trained to generate a corresponding text prompt from a sketch.

A 2D image is created from the sketch inputted at step S210 and the text prompt generated at step S230 (S240). A 3D object is created from the 2D image created at step S240 (S250).

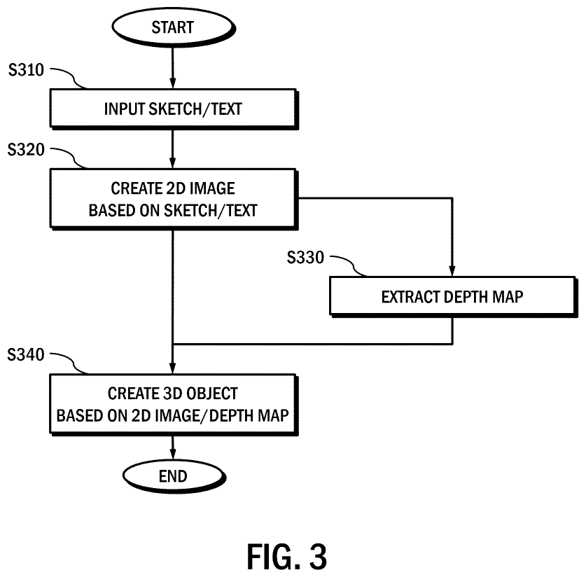

FIG. 3 is a flowchart of a 3D object creation method according to still another embodiment of the disclosure. In the embodiment of the disclosure, a 3D object is created with inputted unstructured sketch and text, and in the middle of creating the 3D object, a depth map is extracted and used.

First, a sketch and a text on a 3D object to create are inputted (S310). A 2D image is created from the sketch and the text inputted at step S310 (S320).

A depth map is extracted from the 2D image created at step S320 (S330). Step S330 may be performed by using a machine learning model which is trained to extract a depth map from a monocular 2D image.

A 3D object is created from the 2D image created at step S320 and the depth map extracted at step S330 (S340). Step 340 may be performed by using a machine learning model which is trained to create a 3D object from a 2D image and a depth map.

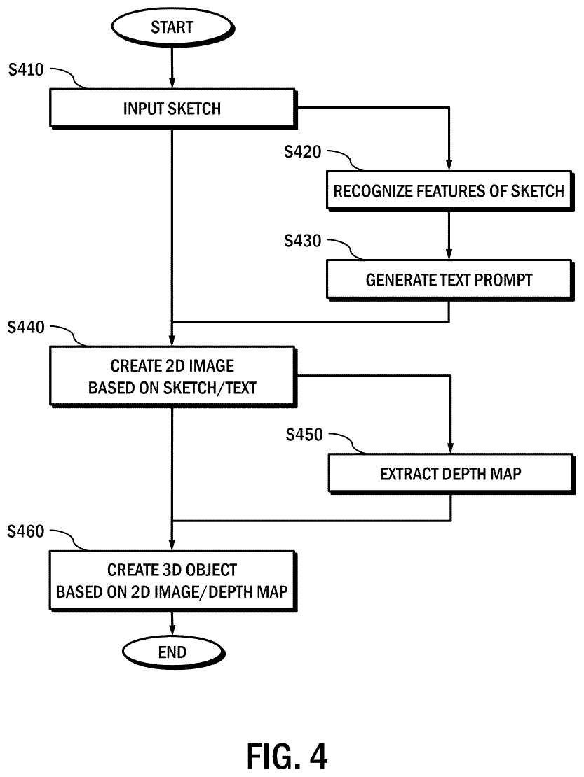

FIG. 4 is a flowchart of a 3D object creation method according to yet another embodiment of the disclosure. In the embodiment of the disclosure, a 3D object is created only with an unstructured sketch without input of a text, and in the middle of creating the 3D object, a text prompt is generated and a depth map is extracted and used.

First, a sketch on a 3D object to create is inputted (S410). Features are recognized by extracting feature points of the sketch inputted at step S410 (S420), and a text prompt explaining the sketch is generated based on the recognized features (S430).

A 2D image is created from the sketch inputted at step S410 and the text prompt generated at step S430 (S440). A depth map is extracted from the 2D image created at step S440 (S450).

A 3D object is created from the 2D image created at step S440 and the depth map extracted at step S450 (S460).

Up to now, the method for creating the 3D objects has been described in detail with reference to preferred embodiments.

In the above-described embodiments, the method enables an individual user to create various 3D objects based on a rough sketch and a text without background knowledge on 3D asset authoring in various genres, such as animations, games, fashion, etc., and to use high-quality 3D assets directly without an additional post-process in each field. For example, in a process of developing by an one-man game developer, 3D assets which are required to produce games may be created only with a sketch or a sketch and a text without requesting an expert designer, and may be directly applied in games.

In the above-described embodiments, the text that is generated by a machine learning model from inputted text or sketch may be incremented through modification, and 3D objects of various styles may be created with respect to the incremented various texts.

For example, when “a luxurious chair” is inputted after a chair is sketched, the corresponding text may be modified to a text prompt like “a chair in the style of Van Gogh's painting”, “a chair made of hardwood”, etc., and various 3D objects on one sketch may be created.

The machine learning models applied to each step in the above-described embodiments may configure the whole system in the zero-shot method by applying a large-scale pretrained model.

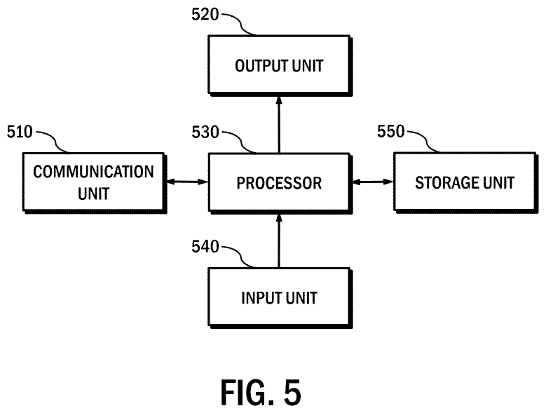

FIG. 5 is a view illustrating a configuration of a 3D object creation system according to a further embodiment of the disclosure. The 3D object creation system according to the embodiment of the disclosure may be implemented by a computing system including a communication unit 510, an output unit 520, a processor 530, an input unit 540, and a storage unit 550 as shown in FIG. 5.

Specifically, the 3D object creation system may be a PC or a smartphone. When the 3D object creation system is a smartphone, the output unit 520 and the input unit 540 may be integrated into a touch screen, and a camera may further be included in the input unit 540. Furthermore, the 3D object creation system may be implemented by a server providing a web-based authoring service.

The communication unit 510 is a communication interface for connecting to an external network or an external device. The output unit 520 is an output means for displaying a result of computing by the processor 530, created 3D objects in the above-described embodiments, and the input unit 540 is a user interface for transmitting a user input, a sketch and a text in the above-described embodiment, to the processor 530.

The processor 530 creates 3D objects according to the procedures described in FIGS. 1, 2, 3, and 4. The storage unit 550 provides a storage space necessary for functions and operations of the processor 530.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A 3D object creation method comprising:
receiving input of a sketch on a 3D object to create;
acquiring a text on the 3D object to create;
creating a 2D image from the sketch and the text; and
creating a 3D object from the 2D image.

2. The 3D object creation method of claim 1, wherein the sketch is a picture of the 3D object which is directly drawn by a user.

3. The 3D object creation method of claim 1, wherein acquiring comprises acquiring the text by receiving the text with the input of the sketch from the user.

4. The 3D object creation method of claim 3, wherein the text received from the user is a text by which the user describes characteristics of the 3D object.

5. The 3D object creation method of claim 3, further comprising generating a plurality of texts by modifying the text inputted from the user,
wherein creating the 2D image comprises creating a plurality of 2D images from the sketch and the plurality of texts,
wherein creating the 3D object comprises creating a plurality of 3D objects from the plurality of 2D images.

6. The 3D object creation method of claim 1, wherein acquiring comprises:
recognizing features by extracting feature points of the received sketch; and
generating a text explaining the sketch based on the recognized features.

7. The 3D object creation method of claim 6, wherein the generated text comprises at least one of a class of an object appearing in the sketch and a semantic description.

8. The 3D object creation method of claim 6, further comprising generating a plurality of texts by modifying the generated text,
wherein creating the 2D image comprises creating a plurality of 2D images from the sketch and the plurality of texts,
wherein creating the 3D object comprises creating a plurality of 3D objects from the plurality of 2D images.

9. The 3D object creation method of claim 1, further comprising extracting a depth map from the 2D image,
wherein creating the 3D object comprises creating the 3D object from the 2D image and the depth map.

10. A 3D object creation system comprising:
a processor configured to receive input of a sketch on a 3D object to create, to acquire a text on the 3D object to create, to create a 2D image from the sketch and the text, and to create a 3D object from the 2D image; and
a storage unit configured to provide a storage space necessary for the processor.

11. A 3D object creation method comprising:
receiving input of a sketch on a 3D object to create;
acquiring a text on the 3D object to create;
creating a 2D image from the sketch and the text;
creating a 3D object from the 2D image; and
outputting the generated 3D object.
